(19) United States
(12) Patent Application Publication
(10) Pub. No.: US 2015/0006897 A1
(43) Pub. Date: Jan. 1, 2015

(54) Apparatus and Method to Obtain Electronic Authentication

(71) Applicant: Broadcom Corporation, Irvine, CA (US)

(72) Inventors: Yasantha Rajakarunanayake, San Ramon, CA (US); William Bunch, Campbell, CA (US); Jacob Mendel, Tel Aviv (IL)

(21) Appl. No.: 13/930,305

(22) Filed: Jun. 28, 2013

(51) Int. Cl. H04L 9/32

(52) U.S. Cl. CPC H04L 9/3255
USPC 713/176

(57) ABSTRACT

A host apparatus to obtain electronic authentication of a request associated with a group, the host apparatus including a processor to receive the request from an external device external to the group, to generate a digital document based on information associated with the request, to transmit the digital document to a trusted entity device for electronic authentication of the request, to receive the digital document from the trusted entity device, to determine whether the electronic authentication of the request was successful, and to process the request when it is determined that the electronic authentication of the request was successful.

### FIELD OF THE DISCLOSURE

The present disclosure is directed to a digital infrastructure for obtaining secure electronic authentication and/or approval from a trusted entity of credentials and/or a request of a requester party.

### BACKGROUND

In various situations, an unknown requester party may request permission to become a member of a group. Additionally or alternatively, the requester party may request permission to gain access to data controlled by the group or to submit data for consideration by the group. However, prior to granting the request of the requester, the existing members of the group would like to obtain authentication from a trusted entity of the request.

### BRIEF DESCRIPTION OF THE DRAWINGS

FIG. 1 illustrates an exemplary communication system for implementing a digital infrastructure according to an embodiment of the present disclosure.

FIG. 2 illustrates an exemplary host according to an embodiment of the present disclosure.

FIG. 3 illustrates an exemplary method for implementing a digital infrastructure according to another embodiment of the present disclosure.

FIG. 4 illustrates a number exemplary method for implementing a digital infrastructure according to another embodiment of the present disclosure.

FIG. 5 illustrates another exemplary communication is probably system for implementing a digital infrastructure according to an embodiment of the present disclosure.

FIG. 6 illustrates a general purpose computer system according to an embodiment of the present disclosure.

### DETAILED DESCRIPTION

The present disclosure provides mechanisms to implement a digital infrastructure to allow the members of a group to obtain secure electronic authentication and/or approval of credentials and/or the request of an unknown requester party from a trusted entity. The group may be, for example, an organized circle or a social network, and include any number of members.

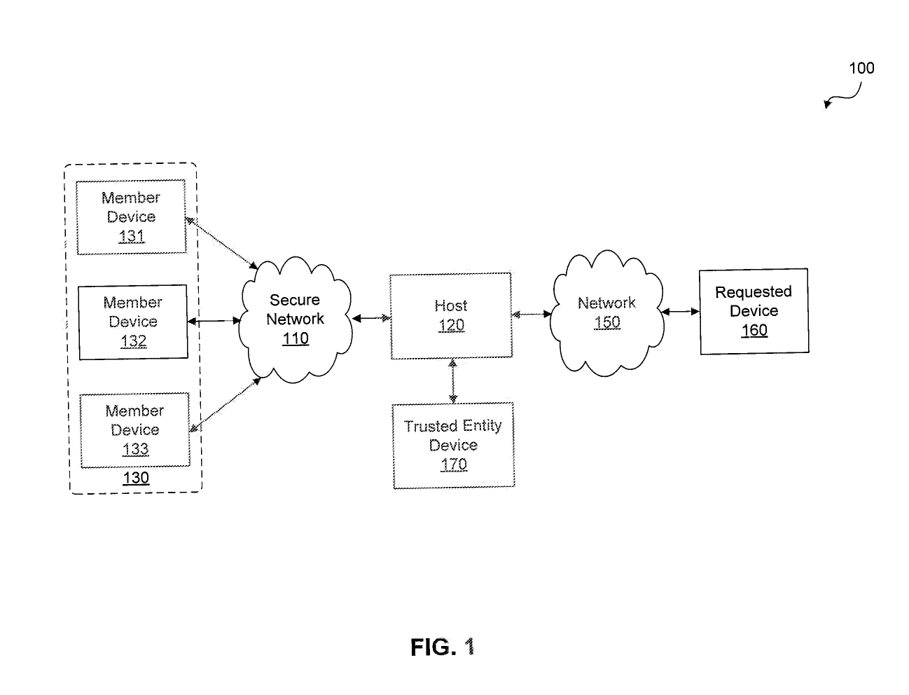

FIG. 1 illustrates an exemplary communication system 100 according to an embodiment of the present disclosure. The communication system 100 may include a host 120 associated and communicating with a group 130 having member devices 131, 132, 133, and a requester device 160. The host 120 may communicate with the member devices 131, 132, 133 through a secured wired or wireless network 110, or through a wireless network capable of operating over, for example, the Internet protocol by using secure channels. Further, the host 120 may communicate with the requester device 160 through a wired or a wireless network 150, the wireless network being capable of operating over, for example, the Internet protocol. Finally, the host 120 may communicate with a trusted entity device 170 over a private and/or secure network, for example, for the purpose of obtaining the electronic authentication.

The member devices 131, 132, 133 may be associated with human members. For example, member device 131 may be a cell phone belonging to human member of the group 130, and member device 132 may be a laptop or tablet associated with the same human member or another human member of the group 130. The member devices may also include printers, storage devices, video and audio recording and playback devices, communication devices, and the like. Even though the host 120 has been illustrated as being separate from the member devices 131, 132, 133, any of the member devices 131, 132, 133 may act as the host 120. As such, the host 120 may be internal or external with respect to the group 110.

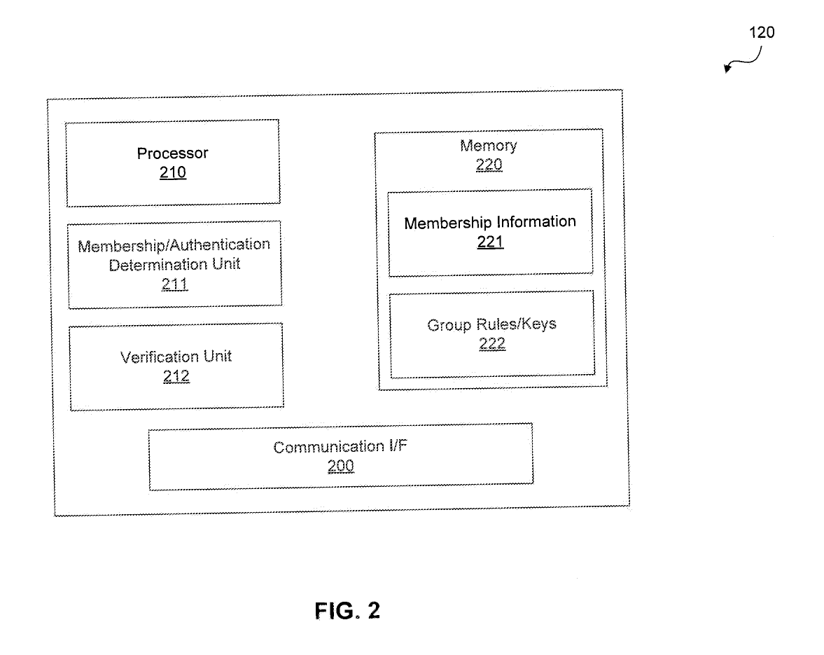

FIG. 2 illustrates an exemplary host 120 according to an embodiment of the present disclosure. The host 120 may include a communication interface (I/F) 200, a processor 210, a secure memory 220, a membership/authentication determination unit 211, and a verification unit 212. The memory 220 may include a membership information section 221 and a group of rules/keys section 222.

The host 120 may use the communication I/F 200 to communicate with the group member devices 131, 132, 133 and with external hosts or devices such as a requester device 160. The host 120 may use the membership/authentication determination unit 211 and the verification unit 112 to process any information and/or requests received from the group member devices 131, 132, 133 or from external hosts or devices. For example, when the host 120 receives a request associated with the group 130, the host 120 may use the membership/authentication determination unit 211 to determine whether the requester device is a member device 131, 132, 133 or an external device, and then may process the request based on the results of the determination. As discussed below, the host 120 may also use the membership/authentication determination unit 111 during the processing of the request to determine whether the authentication of requester device is successful. The host 120 may store membership information including, for example, identification information of the member devices 131, 132, 133 in the membership information section 221. The host 120 may store, for example, rules for managing functions associated with group 130 and for processing requests associated with group 130 in the rules/keys section 222. The host 120 may also store, for example, communication keys to be used for secure communication with the member devices 131, 132, 133 in the rules/keys section 222. Further, the host 120 may store rules for setting up new secure channels with external devices such as other hosts or trusted entities in the rules/keys section 222.

The host 120 may act as a manager and may manage the functions associated with the group 130. For example, the host 120 may manage communication and transfer of data among the existing member devices 131, 132, 133, and also between existing member devices 131, 132, 133 and any external device. Further, the host 120 may be capable of receiving a request transmitted from the requester device 160 over the network 150. The request may be, for example, for permission to access data controlled by the group 130 or for permission to become a member of the group 130. The data controlled by the group 130 may include audio data, video data, pictures, and the like. As the manager, the host 120 may process the received request. For example, when the host 120 receives a request associated with group 130, the host 120 may determine whether the request has been received from an existing member device 131, 132, 133 or from an external requester device 160. In one embodiment, the host 120 may determine that the request has been received from an existing member device 131, 132, 133 when the request is received over the secure network 110. Alternatively, the host 120 may determine that the request was received from an external requester device 160 when the request is received over the network 150. When the host 120 determines that the request has been received from an existing member device 131, 132, 133, the host 120 may authenticate the existing member device. In one embodiment, the host 120 may authenticate the existing member device by requesting and receiving secret information from the existing member device. The secret information may include member identification information and/or previously exchanged information or secret keys between the host 120 and the existing member device,

Alternatively, when the host 120 determines that the request is received from an external requester device 160, the host 120 may authenticate the external requester device 160 by obtaining electronic authentication of received request. in one embodiment, the host 120 may analyze the received request to determine whether the information included in the request (or received along with the request) is sufficient to process the request, or whether additional information is required from the external requester device 160. For example, the host may analyze the received request to determine whether all the relevant credentials (e.g., identity of the user associated with the external requester device 160, purpose for the request, identity of a trusted entity that is being used as a referral, etc.) for the processing of the request have been received along with the request. The host 120 may instruct the external requester device 160 to provide additional information for the processing of the request when the host 120 determines that all the relevant credentials have not been received from the external requester device 160. The host 120 may then receive the additional information from the external requester device 160 in response to the instruction from the host 120. The host 120 may repeat the analyzing, the instructing, and the receiving until all the relevant credentials required to process the request have been received.

Once all the relevant credentials have been received, the host 120 may proceed to create a digital document based on all the information received from the external requester device 160. For example, when the information received from the external requester device 160 includes a letter of referral from a trusted entity, the host 120 may verify the authenticity of the letter of referral. In one embodiment, the host 120 may determine the identity of the trusted entity based on the information associated with the request. For example, if the information associated with the request claims that the requester is an employee of a company, or a relative of a person, then the host 120 may determine the company or the related person to be the trusted entity. The trusted entity may also be an existing member of the group 130.

In one embodiment, the host 120 may implement different levels of trustworthiness with respect to the authentication from the trusted entity based on familiarity of the host 120 with the trusted entity. For example, the host 120 may assign a higher level of trustworthiness to authentication received from a trusted entity that shares a relationship with the host 120 independent of the request from the external requester device 160. Further, the host 120 may assign a lower level of trustworthiness to authentication received from a trusted entity that does not share relationship with the host 120 independent of the request from the external requester device 160.

Now, to authenticate the request that includes the letter of referral, the host 120 may create a digital document including the letter of referral. The host 120 may then securely provide the digital document to the trusted entity device 170 of the determined trusted entity for review and electronic authentication. In one embodiment, the host 120 may encrypt the digital document and/or communicate with the trusted entity device 170 over a secure channel. Further, the host 120 may set up the secure channel between itself and the trusted entity device 170 for the sole purpose of communicating the digital document and receiving the signed digital document. The host 120 may set up the secure channel in accordance with the rules associated with the group 130 that are stored in the rules/keys section 222. The host 120 may also provide encrypted specific instructions to the trusted entity device 170 on how to digitally sign or authenticate the digital document. In one embodiment, the host 120 may provide the instructions to decrypt the encrypted specific instructions. Further, the host 120 may provide the instructions to decrypt the encrypted specific instructions along with the specific instructions or in a separate communication over the set up secure channel.

The trusted entity may review all the information included in the digital document including the referral letter, and confirm whether the information included in the digital document is authentic. For example, the trusted entity device 170 may decrypt the encrypted specific instructions, and then decrypt the encrypted digital document by using the decryption instructions provided by the host 120. Further, when the trusted entity is satisfied that the information in the digital document including the referral letter is authentic, the trusted entity may electronically sign the digital document in accordance with the decrypted specific instructions. Alternatively, when the trusted entity determines that any information in the digital document is inaccurate or that the referral letter is not authentic, the trusted entity may decline to electronically sign the digital document. The trusted entity may also provide reasons for declining to electronically sign the digital document in a communication to the host 120 over the secure channel. The host 120 may decline the request from the requester device 160 if the trusted entity declines to electronically sign the digital document.

Alternatively, once the host 120 securely receives the electronically signed digital document from the trusted entity in accordance with the specific instructions, the host 120 may conclude that information including the referral letter provided by the requester device 160 is accurate and authentic. The host 120 may then proceed to process the request. Now, before granting the request, the host 120 may inform at least one existing member or any number (e.g., a majority) of existing members of the group 130 about the successful authentication of the information provided by the external requester device 160. Further, the host 120 may require the at least one existing member or any number (e.g., a majority) of existing members to approve the request received from the external requester device 160. Alternatively, before granting the request, the host 120 may require each member of the group 130 to approve the request received from the external requester device 160. In order to provide approval, an existing member of the group 130 may be allowed to challenge the information provided by the requester device 160 and request, through the host device 120, clarification information from the requester device 160 to resolve the challenge. The clarification information may include any information known to the user of the external requester device 160 and to the member requesting clarification.

Once approval has been received from the requisite number of group members, the host 120 may proceed to grant the request in accordance with the rules of the group 130. For example, once the responses from the requisite number of existing members have been received, the host 120 may determine that one existing member has denied approval, thereby indicating that the request from the external requester device 160 should be declined. However, the rules of the group 130 may simply require approval from a majority of the existing members in order to grant the request from an external device (e.g., external requester device 160). In this case, even though the one existing member has denied approval, the host 120 may grant the request from the external requester device 160 based on the rules of the group 130 that simply require approval from a majority of the existing members. In one embodiment, the host 120 may resolve the conflict that arises when at least one member of the group denies approval of the request and at least one member of the group approves the request. For example, the host 120 may implement a scheme in which the request is granted when the at least one member of the group 130 that approves the request is a senior member of the group with respect to the at least one member of the group 130 that denies approval of the request, and the request is denied when the at least one member of the group 130 that denies approval of the request is a senior member with respect to the at least one member of the group 130 that approves the request. In one embodiment, the host 120 may implement an appeals process in which a losing member may appeal the decision of the host 120 to grant or deny the request, inconsistent with the losing member's position. Based on determination by the host 120 during the appeals process, the host 120 may require the external requester device 120 to sign, for example, a confidentiality agreement and/or post a bond or collateral prior to granting the request.

In this way, the host 120 enables the secure use of digital documents and electronic signatures/approvals to authenticate a received request before granting the same. It is to be appreciated that the above digital infrastructure provides remotely located families and friends of requesters the ability to securely and electronically vouch for the requesters. As such, the above digital infrastructure enables a high-level trust system where remotely located trusted entities may authenticate and/or approve credentials of a requester.

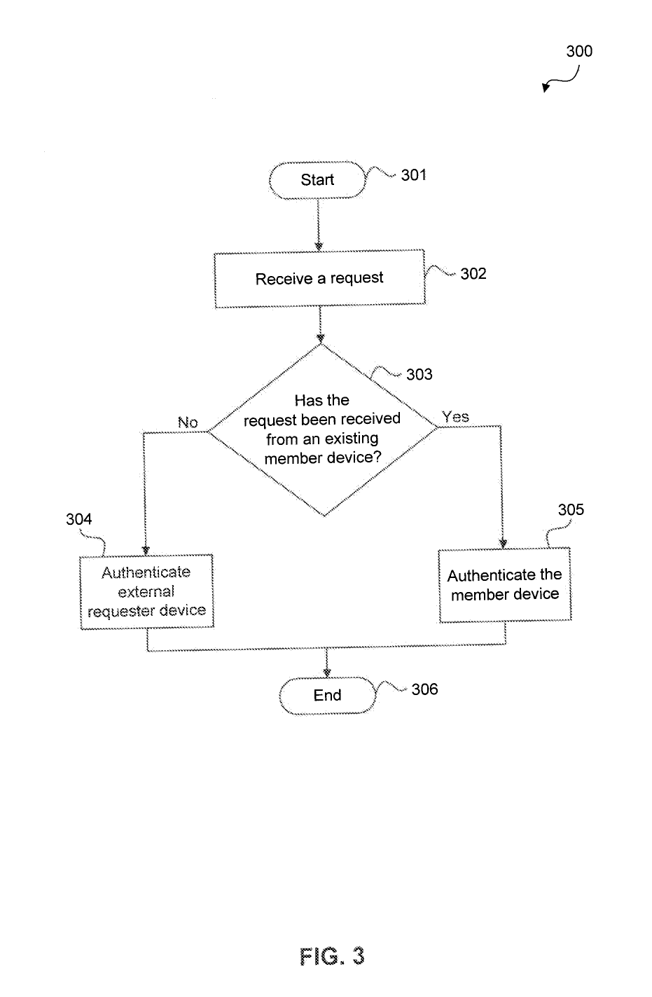

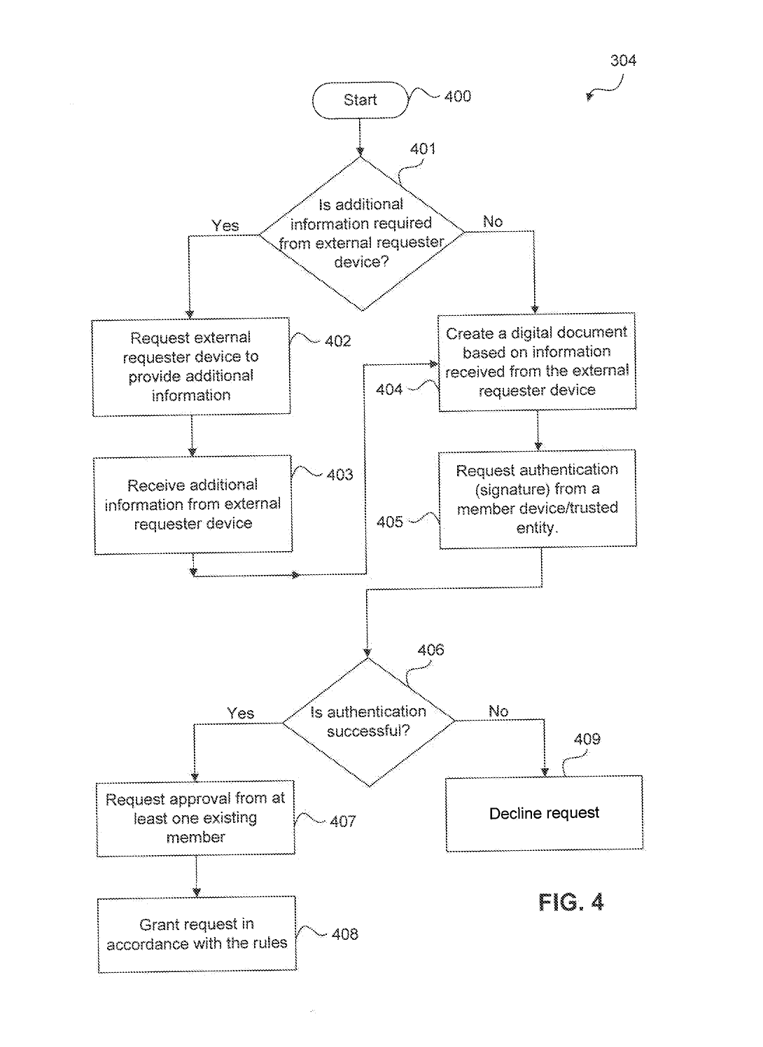

FIG. 3 illustrates an exemplary method 300 in accordance with an embodiment of the present disclosure. The method starts at step 301. At step 302, the host 120 receives a request associated with group 130. At step 303, the host 120 determines whether the request has been received from an existing member device of the group 130 or from an external device. The method moves to step 304 when the host 120 determines that the request has been received from an external device, or moves to step 305 when the host 120 determines that the request has been received from an existing member device of the group 130. At step 304, the host device 120 authenticates the external device by authenticating the information associated with the request, as discussed below in further detail with respect to FIG. 4. At step 305, the host device 120 authenticates the existing member device. The method ends at step 306.

FIG. 4 illustrates the exemplary authentication of the external device in accordance with an embodiment of the present disclosure. The method starts at step 400. At step 401, the host 120 analyzes the information included in the request, and determines whether additional information is required from the external requester device to further process the request. The method moves to step 402 when the host 120 determines that additional information is required from the external requester device, or moves to step 404 when the host 120 determines that no additional information is required from the external requester device 160. At step 402, the host 120 transmits an instruction to the external requester device 160 to provide additional information in order to further process the request. At step 403, the host 120 receives the additional information from the external requester device 160 in response to the transmitted instruction. The method then moves to step 404. At step 404, as discussed above with respect to FIGS. 1 and 2, the host 120 creates a digital document based on information received from the external requester device. At step 405, as discussed above with respect to FIGS. 1 and 2, the host 120 requests the trusted entity to electronically sign the digital document. In one embodiment, step 405 may include encrypting the digital document, setting up a secure channel between the host 120 and a trusted entity device, and communicating the digital document and receiving the electronically signed digital document over the secure channel At step 406, the host 120 receives the response from the trusted entity, and determines whether the trusted entity has electronically signed the digital document, thereby authenticating the information provided by the external requester device 160. The method moves to step 407 when the host 120 determines that the trusted entity has electronically signed the digital document, or moves to step 409 when the host 120 determines that the trusted entity has not electronically signed the digital document. At step 407, the host 120 may grant the request, or optionally, the host 120 may request approval from at least one existing member of the group 130. In one embodiment, the host 120 may transmit the electronically signed digital document and all of the other information included are associated with the request to the at least one existing member of the group 130. At step 408, as discussed above, the host 120 grants the request from the external requester device in accordance with the rules associated with the group 130.

It is to be appreciated that the above methods allow for a trusted party to securely and electronically authenticate credentials (e.g., identity, authenticity of referral document, certifications, transcripts, etc.) of another party. For example, a trusted party may securely and electronically authenticate credentials of a remotely located (e.g., in a foreign country) relative or an associate of the trusted party without having to physically be present with the relative or associate. The digital infrastructure to implement the above methods may be designed with secure hardware, operating system, and/or application layers. Such a secure infrastructure increases the trustworthiness and reliability associated with the secure electronic authentication. In addition, productivity associated with processing the received request and the authentication of the credentials is increased. The disclosed digital infrastructure may be associated with or connected to any of group or network including government offices, churches, employers, schools, banks, visa offices, social groups on social networking websites, background verifying agencies, and the like.

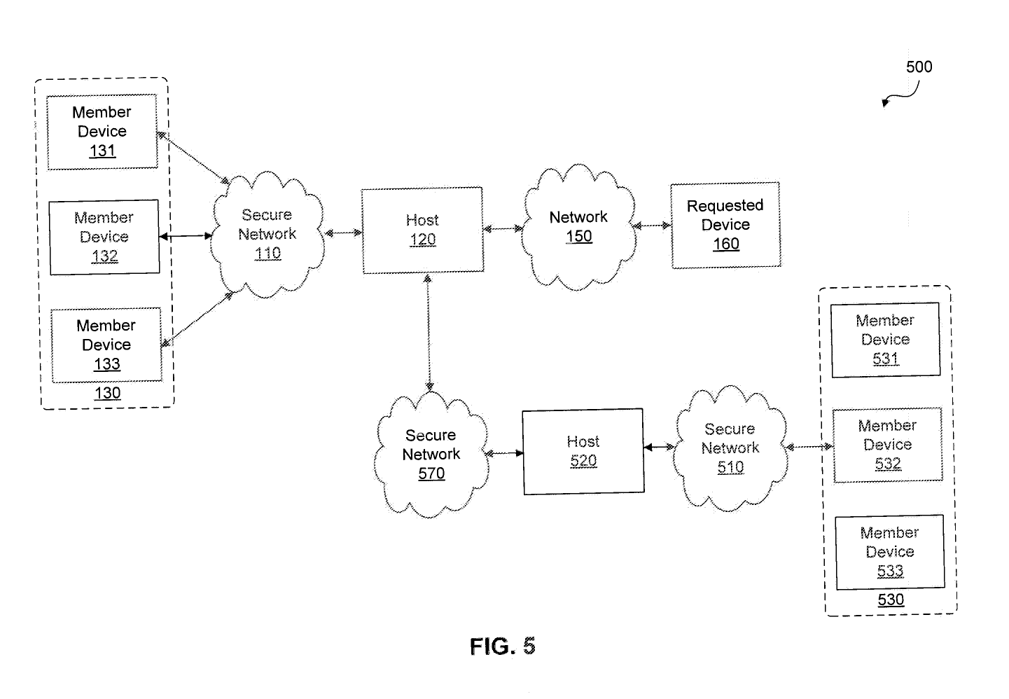

FIG. 5 illustrates an exemplary communication system 500 according to an embodiment of the present disclosure. The communication system 500 may include the components included in system 100, discussed above with respect to FIG. 1. Further, the communication system 500 may include host 520 associated with a group 530 having member devices 531, 532, 533. The host 520 may communicate with the member devices 531, 532, 533 of the group 530 over a secure network 510. host 520 may be associated with group 530 in a similar way that host 120 is associated with group 130 in that host 520 may act as a manager and may manage the functions associated with the group 530.

In one embodiment, the trusted entity that the host 120 communicates with, as discussed above with respect to FIGS. 1-4, may be the members of the group 530 or a single member of the group 530. In this case, the host 120 may set up a secure network 570 to communicate with host 520 in order to securely communicate the digital document and to receive the electronically signed digital document from the members of the group 530 or from the single member of the group 530. The host 120 may communicate the digital document and receive the electronically signed digital document or a declination to electronically sign the digital document in an analogous way as discussed above with respect to FIGS. 1-4.

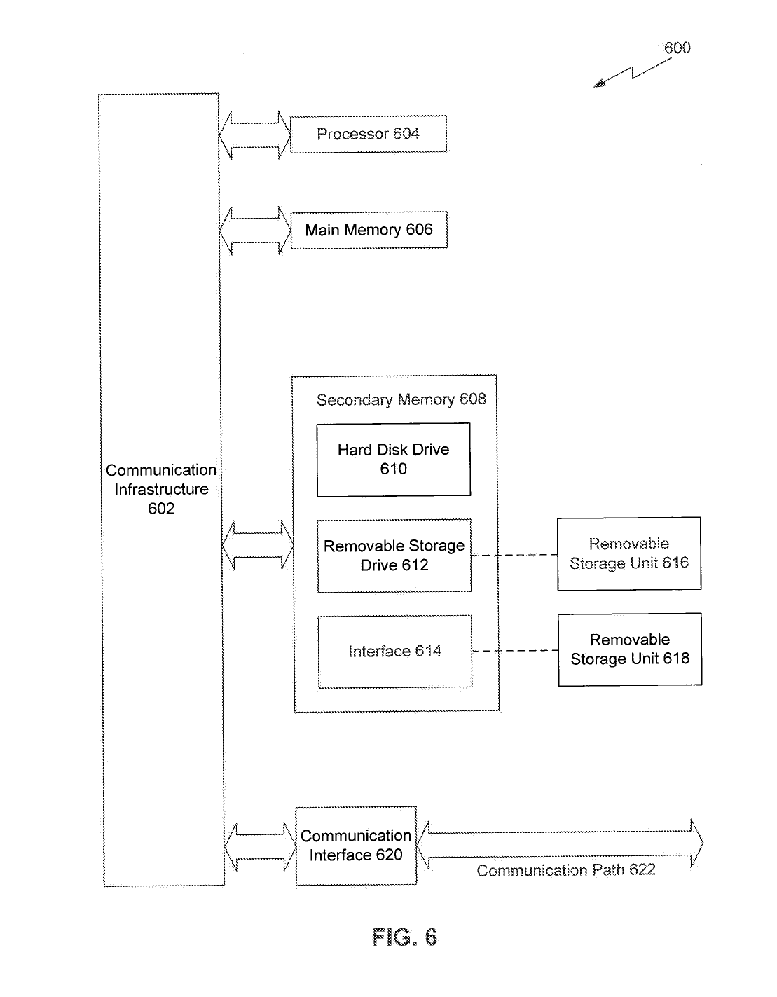

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 600 is shown in FIG. 6. One or more of the features depicted in FIGS. 1-5 (e.g., host 120, 520; member devices 131, 132, 133, 531, 532, 533; requester device 160; etc.) and their corresponding algorithms can be executed on one or more distinct computer systems 600, or a portion thereof. Furthermore, any functions performed by any of the above features can be implemented on one or more distinct computer systems 600.

A computer system 600 includes one or more processors, such as processor 604. Processor 604 can be a special purpose or a general purpose digital signal processor. Processor 604 is connected to a communication infrastructure 602 (for example, a bus or network). Various software implementations are described in terms of this exemplary computer system. After reading this description, it will become apparent to a person skilled in the relevant art(s) how to implement the disclosure using other computer systems and/or computer architectures.

Computer system 600 also includes a main memory 606, preferably random access memory (RAM), and may also include a secondary memory 608. Secondary memory 608 may include, for example, a hard disk drive 610 and/or a removable storage drive 612, representing a floppy disk drive, a magnetic tape drive, an optical disk drive, or the like. Removable storage drive 612 reads from and/or writes to a removable storage unit 616 in a well-known manner. Removable storage unit 616 represents a floppy disk, magnetic tape, optical disk, or the like, which is read by and written to by removable storage drive 612. As will be appreciated by persons skilled in the relevant art(s), removable storage unit 616 includes a computer usable storage medium having stored therein computer software and/or data.

In alternative implementations, secondary memory 608 may include other similar means for allowing computer programs or other instructions to be loaded into computer system 600. Such means may include, for example, a removable storage unit 618 and an interface 614. Examples of such means may include a program cartridge and cartridge interface (such as that found in video game devices), a removable memory chip (such as an EPROM, or PROM) and associated socket, a thumb drive and USB port, and other removable storage units 618 and interfaces 614 which allow software and data to be transferred from removable storage unit 618 to computer system 600.

Computer system 600 may also include a communications interface 620. Communications interface 620 allows software and data to be transferred between computer system 600 and external devices. Examples of communications interface 620 may include a modem, a network interface (such as an Ethernet card), a communications port, a PCMCIA slot and card, etc. Software and data can be transferred via communications interface 620 through a communications path 622. Communications path 622 may be implemented using wire or cable, fiber optics, a phone line, a cellular phone link, an RF link and other communications channels.

As used herein, the terms “computer program medium” and “computer readable medium” are used to generally refer to non-transitory, tangible storage media such as removable storage units 616 and 618 or a hard disk installed in hard disk drive 610. These computer program products are means for providing software to computer system 600.

Computer programs (also called computer control logic) are stored in main memory 606 and/or secondary memory 608. Computer programs may also be received via communications interface 620. Such computer programs, when executed, enable the computer system 600 to implement the present disclosure as discussed herein. In particular, the computer programs, when executed, enable processor 604 to implement the processes of the present disclosure, such as any of the methods described herein. Accordingly, such computer programs represent controllers of the computer system 600. Where the disclosure is implemented using software, the software may be stored in a computer program product and loaded into computer system 600 using a removable storage drive 612, interface 614, or communications interface 620.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### Conclusion

In the above description, numerous specific details are set forth in order to provide a thorough understanding of the disclosure. However, it will be apparent to those skilled in the art that the disclosure including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

It is to be appreciated that the Detailed Description section, and not the Abstract section, is intended to be used to interpret the claims. The Abstract section may set forth one or more but not all exemplary embodiments of the present disclosure as contemplated by the inventor(s), and thus, are not intended to limit the present disclosure and the appended claims in any way.

The present disclosure has been described above with the aid of functional building Hocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A host apparatus to obtain electronic authentication of a request associated with a group, the host apparatus comprising:
a processor configured to:
receive the request from an external device external to the group;
generate a digital document based on information associated with the request;
transmit the digital document to a trusted entity device for electronic authentication of the request;
receive the digital document from the trusted entity device, and determine whether the electronic authentication of the request was successful; and
process the request when it is determined that the electronic authentication of the request was successful.

2. The host apparatus of claim 1, wherein, to process the request, the processor is further configured to:
transmit the digital document to at least one member of the group for approval of the request; and
grant the request when approval from the at least one member of the group is received.

3. The host apparatus of claim 1, wherein, upon receiving the request from the external device, the processor is further configured to determine whether additional information associated with the request is required to process the request, and to request the additional information from the external device prior to generating the digital document when it is determined that the additional information is required.

4. The host apparatus of claim 1, wherein the processor is configured to set up a secure wireless channel between the host apparatus and the trusted entity device, and to transmit the digital document to the trusted entity device over the secure wireless channel.

5. The host apparatus of claim 1, wherein the processor is configured to encrypt the digital document, and to transmit the digital document encrypted to the trusted entity device.

6. The host apparatus of claim 2, wherein the processor is configured to transmit the digital document to the at least one member of the group over a secure network.

7. The host apparatus of claim 2, wherein the at least one member of the group includes a plurality of members, and the processor is configured to grant the request when approvals from each of the plurality of members are received.

8. The host apparatus of claim 2, wherein the at least one member of the group includes a plurality of members, and the processor is configured to grant the request when approvals from a majority of the plurality of members are received.

9. The host apparatus of claim 1, wherein the processor is configured to determine that the electronic authentication of the request was successful when the digital document received from the trusted entity device includes a digital signature.

10. A method for obtaining electronic authentication of a request associated with a group, the method comprising:
receiving, in a processor, a request from an external device external to the group, the request being associated with the group;
generating, in the processor, a digital document based on information associated with the request;
transmitting, from the processor, the digital document to a trusted entity device for electronic authentication of the request;
receiving, at the processor, the digital document from the trusted entity device, and determining whether the electronic authentication of the request was successful; and
processing, in the processor, the request upon determining that the electronic authentication of the request was successful.

11. The method of claim 10, wherein the processing the request comprises:
transmitting the digital document to at least one member of the group for approval of the request; and
granting the request upon receiving approval from the at least one member of the group.

12. The method of claim 10, further comprising:
determining, upon receiving the request from the external device, whether additional information associated with the request is required to process the request; and
requesting the additional information from the external device prior to generating the digital document upon determining that the additional information is required.

13. The method of claim 10, wherein transmitting the digital document to the trusted entity device comprises:
setting up a secure wireless channel between the processor and the trusted entity device, and
transmitting the digital document to the trusted entity device over the secure wireless channel.

14. The method of claim 10, wherein the transmitting the digital document to the trusted entity device comprises:
encrypting the digital document, and transmitting the encrypted digital document to the trusted entity device.

15. The method of claim 11, wherein the transmitting the digital document to at least one member of the group comprises transmitting the digital document to the at least one member of the group over a secure network.

16. The method of claim 11, wherein the at least one member of the group includes a plurality of members, and the processing the request comprises granting the request upon receiving approvals from each of the plurality of members.

17. The method of claim 11, wherein the at least one member of the group includes a plurality of members, and the processing the request comprises granting the request upon receiving approvals from a majority of the plurality of members.

18. The method of claim 10, wherein the determining whether the electronic authentication of the request was successful comprises determining whether the digital document received from the trusted entity device includes a digital signature.

19. A communication system for obtaining electronic authentication, the communication system comprising:
at least one member device included in group associated with the communication system;
an external device external to the group; and
a host processor configured to:
receive a request from the external device, the request being associated with the group;
generate a digital document based on information associated with the request;
transmit the digital document to a trusted entity device for electronic authentication of the request;
receive the digital document from the trusted entity device, and determine whether the electronic authentication of the request was successful; and
process the request when it is determined that the electronic authentication of the request was successful.

20. The communication system of claim 19, wherein, when it is determined that the electronic authentication of the request was successful, the host processor is further configured to:
transmit the digital document to at least one member of the group for approval of the request; and
grant the request when approval from the at least one member of the group is received.
